(19) United States
(12) Patent Application Publication
(10) Pub. No.: US 2007/0192519 A1
(43) Pub. Date: Aug. 16, 2007

(54) ELECTRONIC DEVICE CAPABLE OF EXTENDING USB PORT AND CONCEALING POWER LINE SUPPLYING THERETO AND ELECTRONIC APPARATUS HAVING THE SAME

(75) Inventors: Ting Hui Chih, Hualien City (TW); Min Jye Chen, Miaoli (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/669,041

(22) Filed: Jan. 30, 2007

(30) Foreign Application Priority Data
Feb. 13, 2006 (TW) TW95104729

(51) Int. Cl. G06F 13/38

(52) U.S. Cl. 710/62

(57) ABSTRACT

An external electronic device, coupled to a main electronic apparatus by USB, comprises a first USB connector connecting with a first USB port on the main electronic apparatus, and at least one extended USB port directly and electrically connected with the first USB connector for connecting other USB devices with the main electronic apparatus. The external electronic device may further comprise a second USB connector for coupling to a second USB port on the main electronic apparatus, and a circuit module coupled to the second connector, wherein the circuit module is powered by the main electronic apparatus via the second USB port rather than by a power cable.

### BACKGROUND OF THE INVENTION

1. Field of the Invention

The invention relates to external electronic devices, and in particular to external USB electronic devices capable of coupling to a main electronic apparatus having at least two USB ports and extending the USB ports of the main electronic apparatus.

2. Description of the Related Art

USB devices conventionally require USB cabling to connect with a main electronic apparatus via USB ports. Alternatively, the USB device may be enclosed in a case comprising a USB connector, coupled to the main electrical apparatus. The case occupies space and may cover the other USB ports of the main electronic apparatus.

USB ports on a main electronic apparatus may act as power sources for external electronic devices such as monitor-mounted speakers. In conventional LCD monitors, the USB ports may be disposed on sides of the LCD monitors. When a conventional monitor-mounted speaker enclosed in a large case with USB connector is mounted to one of the USB port of a conventional LCD monitor, the size of the case of the conventional monitor-mounted speaker is too large and may obstruct the other USB ports on the sides of the conventional LCD monitor.

### BRIEF SUMMARY OF THE INVENTION

The invention provides an external electronic device coupled to a main electronic apparatus via a USB port. The external electronic device comprises a first USB connector connecting with a first USB port on the main electronic apparatus. The external electronic device further comprises at least one extended USB port directly and electrically connected with the first USB connector. The main electronic apparatus can be coupled with another USB device via the extended USB port on the external electronic device. The external electronic device further comprises a second USB connector for coupling to a second USB port on the main electronic apparatus, and a circuit module coupled to the second USB connector. The circuit module is powered by the main electronic device via the second USB port rather than by a power cable.

The invention also provides an electronic system comprising a main electronic apparatus comprising USB ports, and an external electronic device. The external electronic device comprises a first USB connector for connecting with a first USB port on the main electronic apparatus. The external electronic device further comprises an extended USB port directly and electrically connected with the first USB connector. The main electronic apparatus can be coupled with another USB device via the extended USB port on the external electronic device. The external electronic device further comprises a second USB connector for coupling to a second USB port on the main electronic apparatus, and a circuit module coupled to the second USB connector. The circuit module is powered by the main electronic device via the second USB port rather than by a power cord.

### BRIEF DESCRIPTION OF THE DRAWINGS

The invention can be more fully understood by reading the subsequent detailed description and examples with references made to the accompanying drawings, wherein:

FIG. 1A is a block diagram of an electronic system of the invention;

FIG. 1B is a block diagram of another exemplary embodiment of the external electronic device;

FIG. 2A shows an embodiment of the invention, which comprises a LCD monitor and side-mounted speakers;

FIG. 2B describes FIG. 2A in detail;

FIG. 2C shows an exemplary embodiment of the side-mounted speake; and

FIG. 2D shows another exemplary embodiment for the side-mounted speaker

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

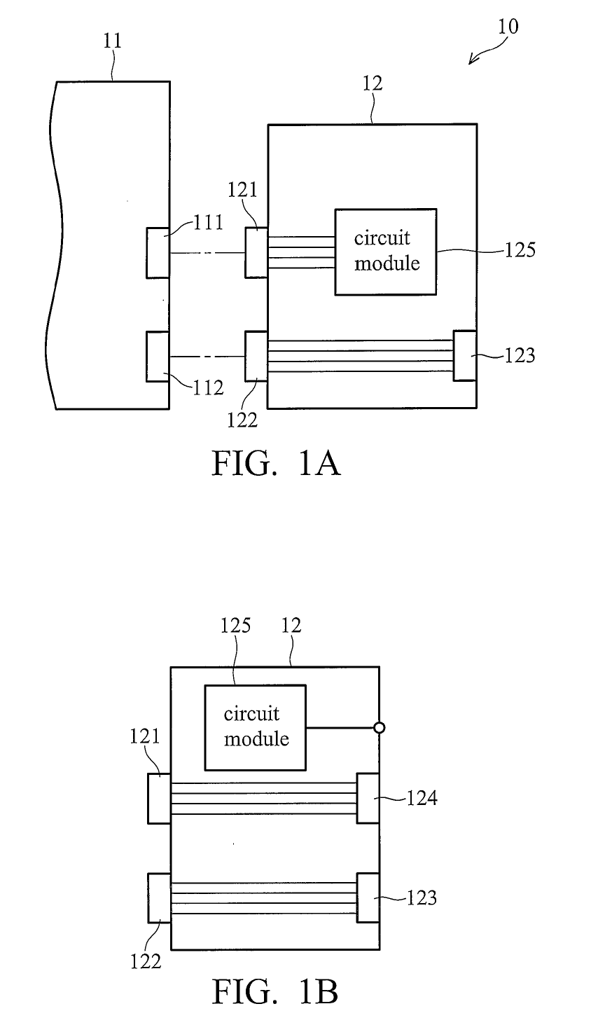

FIG. 1A is a block diagram of an electronic system of the invention. An electronic system 10 comprises a main electronic apparatus 11 and an external electronic device 12.

The main electronic apparatus 11 is an electronic apparatus with USB ports such as a desktop, notebook, or LCD for example. The main electronic apparatus 11 has at least two USB ports 111 and 112 for connecting to the external electronic device 12. In another embodiment (not shown), the main electronic apparatus 11 only has one USB port 112, and the external electronic device 12 only has a USB connector 122 for coupling with the USB port 112, and a USB port 123 electrically coupled to the USB connector 122. Another USB device can be coupled to the main electronic apparatus 11 by connecting with the USB port 123.

In FIG. 1A, the USB connector 121 and 122 of the external electronic device 12 are disposed on the case of the external electronic device 12. The external electronic device 12 is coupled to the main electronic apparatus 11 by connecting the USB connectors 121 and 122 to the USB ports 111 and 112, respectively.

The external electronic device 12 further comprises a USB port 123, electrically coupled to the USB connector 122, for extending the USB port 112 on the main electronic apparatus. The USB port 123 can be connected with another USB device.

A circuit module 125 is coupled to the USB port 121 to transmit data via USB interface. The circuit module 125 can be implemented as a sound device, a storage device or other device.

In another embodiment, the USB port 121 acts only as a power source for the circuit module 125 and with no transmission of data with the circuit module 125 implemented as a speaker or lighting device coupled to the USB connector 121 and powered by the main electronic apparatus 11 via USB.

FIG. 1B is a block diagram of another exemplary embodiment of the external electronic device 12 with electronic apparatus 11 (not shown) comprising at least two USB ports 111 and 112, although disclosure not limited thereto. The external electronic device 12 comprises another USB port 124 directly coupled to the USB connector 121. Data processed by the circuit module 125 is independent of the USB connectors 121 and 122. For example, the circuit module 125 maybe a speaker which receives audio signals via another signal connector. The speaker power signal (not shown) is supplied by the USB connector 121, and the speaker is connected to the main electronic apparatus 11 with no need for a power cable. In FIG. 1B, the USB port 123 of the external electronic device is an extended USB port for a USB port in the main electronic apparatus 11. For example, a USB connector (not shown) connecting to the extended USB port 123 is electrically coupled to the USB port 112 of the main electronic apparatus 11.

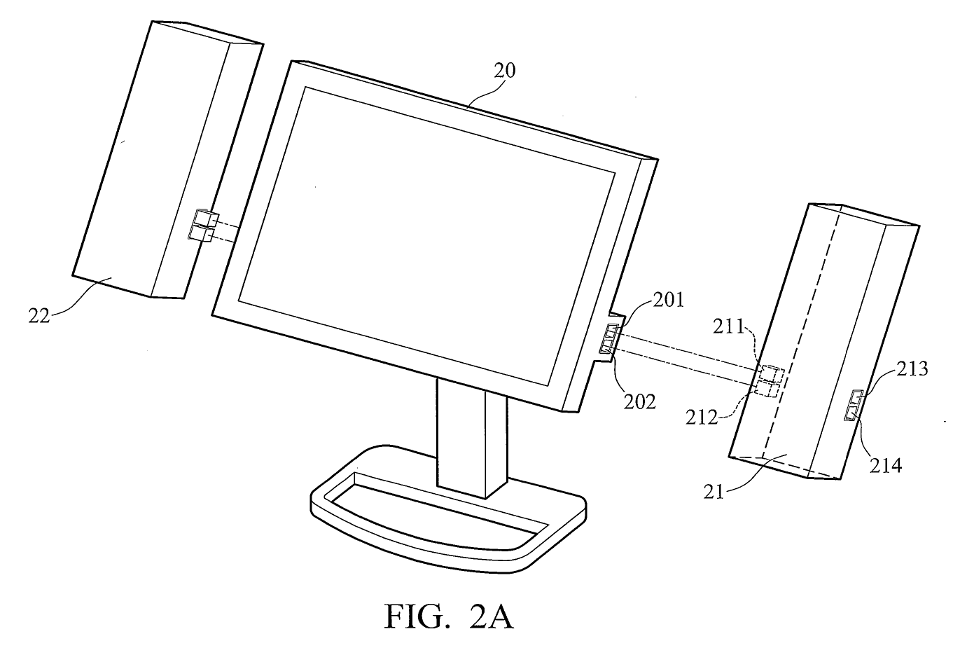

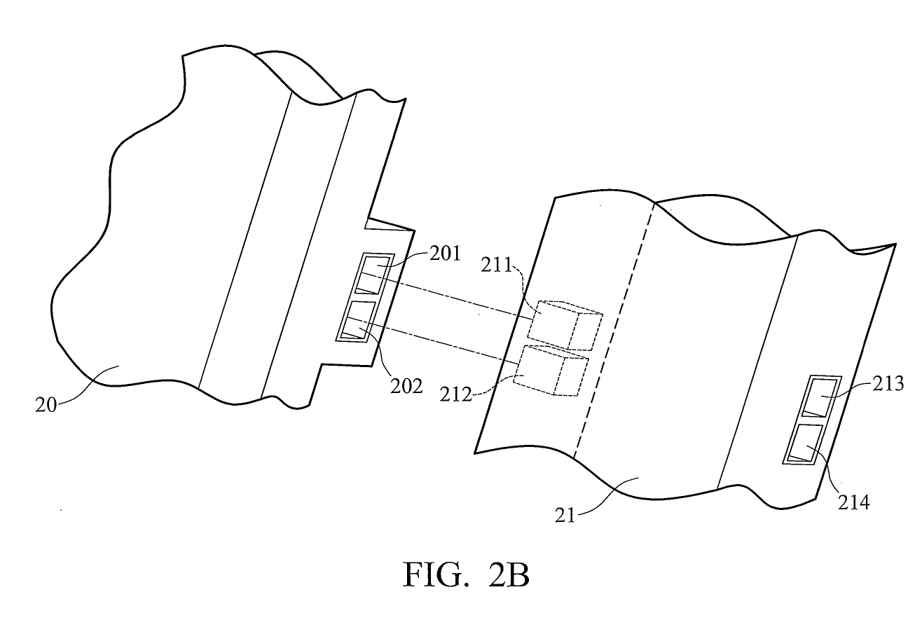

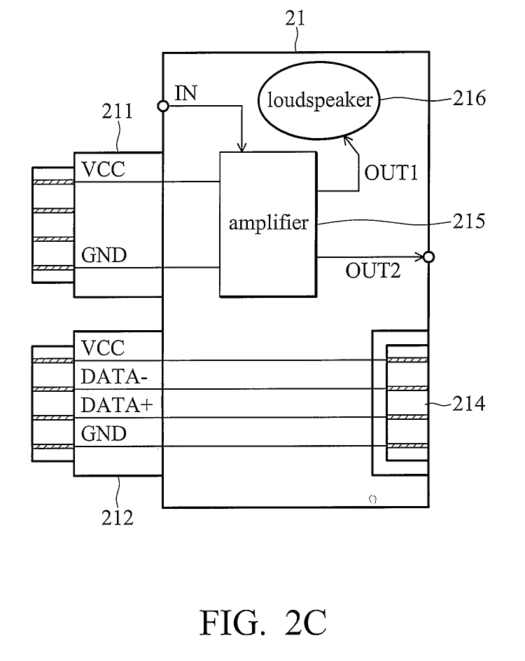

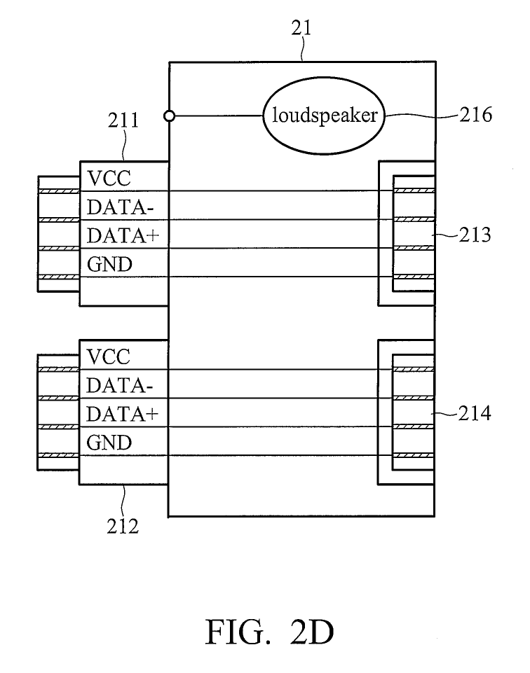

FIG. 2A shows an embodiment of the invention, which comprises a LCD monitor 20 and side-mounted speakers (21 and 22). FIG. 2B describes FIG. 2A in detail. Each side of the LCD monitor 20 here comprises two USB ports although the disclosure is not limited thereto.

In FIG. 2A and FIG. 2B, each side of the LCD monitor 20 has two USB ports (only one side shown in FIG. 2B) 201 and 202. The side-mounted speakers 21 and 22 are connected to the LCD monitor 20 via USB connectors of the speakers. As shown in FIG. 2B, by connecting the USB connectors 211 and 212 with the USB ports 201 and 202 respectively, the side-mounted speaker 21 is connected with the LCD monitor 20 with no need for a power cable.

FIG. 2C shows an exemplary embodiment of the side-mounted speaker 21 which comprises USB connectors 211 and 212, a USB port 214, an amplifier 215, and a loudspeaker 216. The USB connector 211 connected with amplifier 215 is operative to receive power signals (VCC and GND) with no external cable required. The side-mounted speaker 21 is connected with the LCD monitor 20 with no need for a power cable. The amplifier 215 further receives an audio input signal IN and generates audio output signals OUT1 and OUT2. The audio output signal OUT1 is transmitted to the loudspeaker 216. The audio output signal OUT2 can be transmitted to another loudspeaker for generating another channel sound. By connecting the USB port 214 with the USB connector 212, which can be connected with the USB port 202 of the LCD monitor 20, other USB devices can be coupled to the LCD monitor 20 via the USB port 214.

FIG. 2D shows another exemplary embodiment for the side-mounted speaker 21 described in FIG. 2A and FIG. 2B. As shown in FIG. 2D, side-mounted speaker 21 comprises USB connectors 211 and 212, USB ports 213 and 214, and a loudspeaker 216. The loudspeaker 216 is operative to receive an audio signal and to generate a single channel sound. The USB ports 213 and 214 respectively coupled to the USB connectors 211 and 212 are operative to connect with other USB devices.

While the invention has been described by way of example and in terms of preferred embodiment it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An external electronic device, coupled to a main electronic apparatus, comprising:
a first USB connector connecting with a first port of the main electronic apparatus; and
at least one extended USB port for extending the first USB port of the main electronic apparatus, wherein the extended USB port is directly connected with the first USB connector.

2. The external electronic device as claimed in claim 1 further comprising:
a second USB connector coupled to a second USB port of the main electronic apparatus; and
a circuit module coupled to the second USB connector to receive signals from the main electronic apparatus.

3. The external electronic device as claimed in claim 2, wherein the circuit module is implemented as a sound device.

4. The external electronic device as claimed in claim 2, wherein the circuit module is implemented as a storage device.

5. The external electronic device as claimed in claim 2, wherein the circuit module is powered by the main electronic apparatus via the second USB connector.

6. An electronic system, comprising:
a main electronic apparatus comprising a first USB port;
an external electronic device, comprising:
a first USB connector connecting with the first USB port of the main electronic apparatus; and
at least one extended USB port for extending the first USB port of the main electronic apparatus, wherein the extended USB port is directly connected with the first USB connector.

7. The electronic system as claimed in claim 6, the main electronic apparatus further comprising a second USB port; the external electronic device further comprising a second USB connector coupled to the second USB port of the main electronic apparatus, and a circuit module coupled to the second USB connector for receiving signals from the main electronic apparatus.

8. The electronic system as claimed in claim 7, wherein the circuit module is implemented as a sound device.

9. The electronic system as claimed in claim 7, wherein the circuit module is implemented as a storage device.

10. The electronic system as claimed in claim 7, wherein the circuit module is powered by the main electronic apparatus via the second USB connector.

11. The electronic system as claimed in claim 6, wherein the main electronic apparatus is implemented as a desktop.

12. The electronic system as claimed in claim 6, wherein the main electronic apparatus is implemented as a notebook.

13. The electronic system as claimed in claim 6, wherein the main electronic apparatus is implemented as a liquid crystal display.
